(19) United States
(12) Patent Application Publication
(10) Pub. No.: US 2002/0118178 A1
(43) Pub. Date: Aug. 29, 2002

(54) Keypad scanner with serial input and output

(76) Inventors: Mairtin P. O'Conghaile, Cheathru Rua (IE); Tadhg Creedon, Furbo (IE)

Correspondence Address: NIXON & VANDERHYE P.C.,, 1100 North Glebe Rd., 8th Floor, Arlington, VA, 22201-4714, US

(21) Appl. No.: 09/860,642

(22) Filed: May 21, 2001

(30) Foreign Application Priority Data
Feb. 24, 2001 (GB) 0104645.7

(51) Int. Cl. G09G 5/00

(52) U.S. Cl. 345/173

(57) ABSTRACT

A key pad scanner having a shift register driving the column lines and a parallel-in serial-out register coupled to the row lines of the keypad Each scanning cycle comprises a multiplicity of sub-cycles in of which serial data signals for the shift register identify a single respective one of the column lines The scanner may be coupled to an ASIC entirely by serial data signals

### FIELD OF THE INVENTION

This invention relates to a keypad scanner for determining which key or keys may be pressed in a keypad having a multiplicity of keys arranged in rows and columns The invention particularly concerns a keypad scanner of which the scanning is controlled and the output is transmitted both by serial digital data signals

### BACKGROUND TO THE INVENTION

There exists a considerable variety of schemes for providing a digital data output identifying which key or keys of the keypad have been depressed For example. the keys may be coupled to a common line as well as to each of a row line and a column line so that on depression of a key the respective row line and column line are each energised or put into a predetermined state (for example ‘high’). the row lines and column lines each being scanned by some suitable circuit to determine which are in the high state

The present invention particularly concerns a keypad scanner for use with a generally known form of keypad in which the depression of a key couples a corresponding column line to a respective row line so that the status (for example ‘high’ or ‘1’) of the column line is indicated by the status of the respective row line The invention particularly relates to a keypad scanner which is. for example. intended for control by an application specific integrated circuit which can provide clock controlled signals for the scanner In such a context it is desirable to minimise the pins or terminal connections provided on the ASIC. which commonly requires a large number of pins or terminal connections for other purposes

### SUMMARY OF THE INVENTION

The present invention particularly concerns a keypad scanner which receives in a scanning cycle a plurality of sub-cycles wherein in each sub-cycle the scanning signal indicates a single column line. and which provides in the scanning cycle a serial readout signal denoting the status of the row lines The keypad scanner includes a shift register into which the scanning signal is shifted and a parallel input serial-output register associated with the rows to provide the output signal. The scanning and readout signals are preferably temporarily stored so that a key which has been depressed can be identified

Further features and advantages of the invention will be apparent from the following description with reference to the accompanying drawings

### BRIEF DESCRIPTION OF THE DRAWINGS

FIG. 1 is an explanatory diagram showing a key pad.

FIG. 2 is a diagram illustrating the scanning scheme according to the invention applied to the keypad shown in FIG. 1.

FIG. 3 illustrates a particular embodiment of a keypad scanner according to the invention:

FIG. 4 is an illustration of part of an ASIC arranged to provide scanning signals for a specific embodiment of the invention.

FIG. 5 illustrates a timing diagram for signals employed in the embodiment shown in FIG. 4

### DETAILED DESCRIPTION

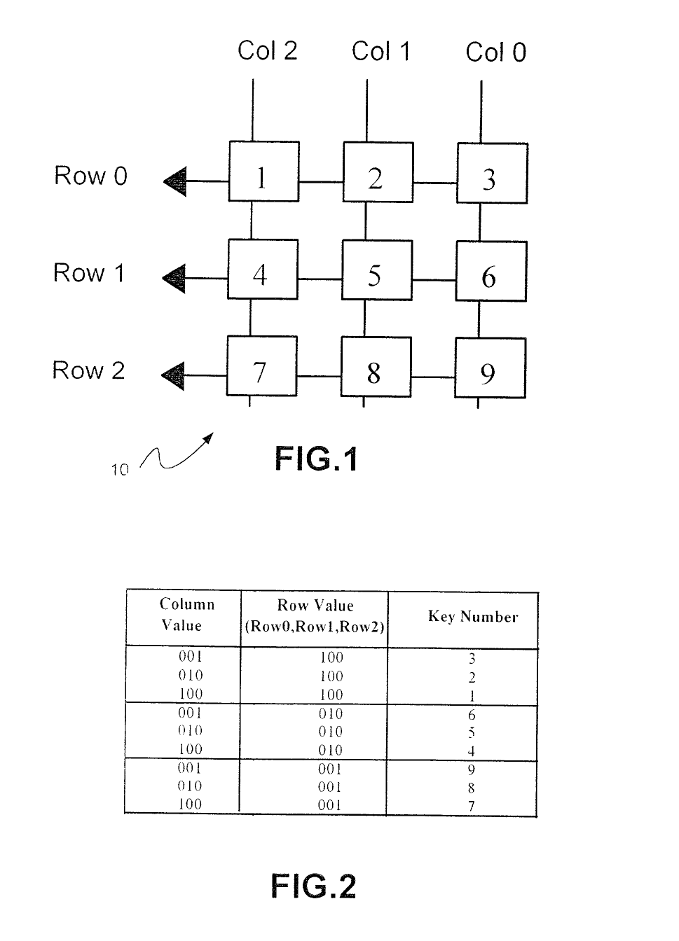

FIG. 1 of the drawings illustrates in schematic form a keypad. which. for ease of explanation. has three rows of three keys. the keys being numbered 1 to 9The keys are associated with a set of column lines. column 0. column 1 and column 2 and a set of row lines. row 0. row 1 and row 2 The keys are organised in known manner so that for example the depression of key 3 will couple (in any convenient manner) the column 0 line to the row 0 line Thus a ‘high’ signal on column 0 will be communicated to the row 0 line.

In practice there may be a greater multiplicity of keys in each of the rows and columns The extension of the invention to arbitrary numbers of rows and columns will be clearly apparent from the explanation that follows Moreover. the coupling between the lines need not be direct The allocation of the designations ‘1’ or ‘0’. ‘high’. or ‘low’ and even the designations of rows and columns may be interchanged In the present invention it will be assumed that a select signal is applied to one of the column lines in any cycle of operation and that the corresponding output (if any) from the row lines will be sensed immediately thereafter. but as indicated the designation ‘column’ and ‘row’ is arbitrary The physical realisation of the keys is not intended to be directly relevant to the invention

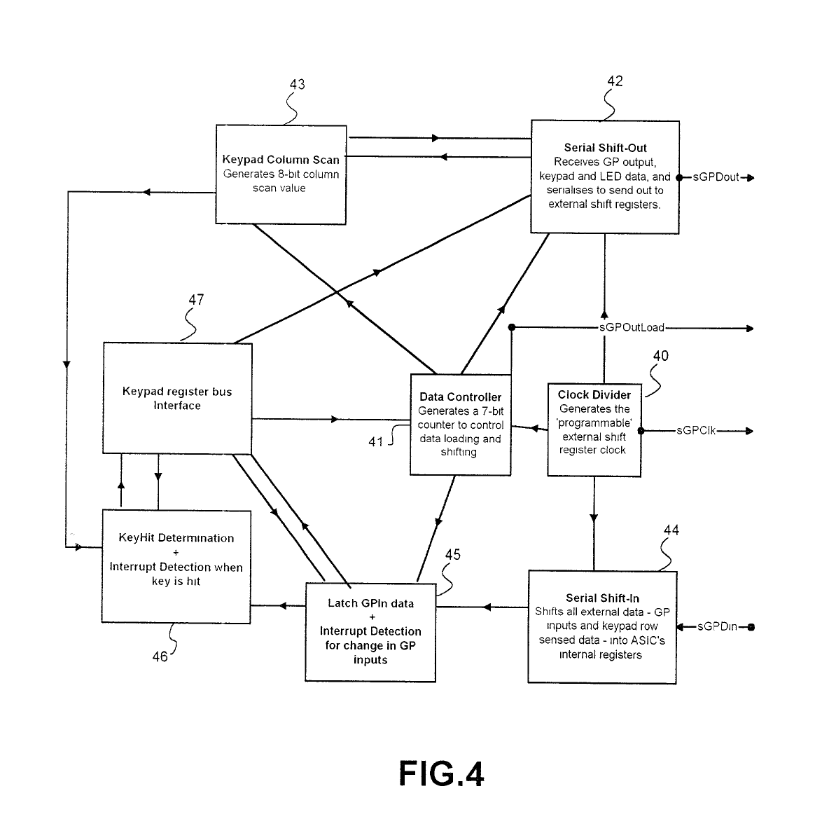

Still referring to FIG. 1. it will be presumed, and more particularly described with reference to FIG. 4. that a shift register is provided for the column lines so that each of the stages is associated with a respective one of the column lines Further. it will be presumed. and more particularly described with reference to FIG. 4. that a parallel-in. serial-out (PISO) register is associated with the row lines so that. on receipt of a parallel load signal. the current statuses of the row lines are stored in the respective stages of the PISO register. and the resulting data signal may be read out in serial manner

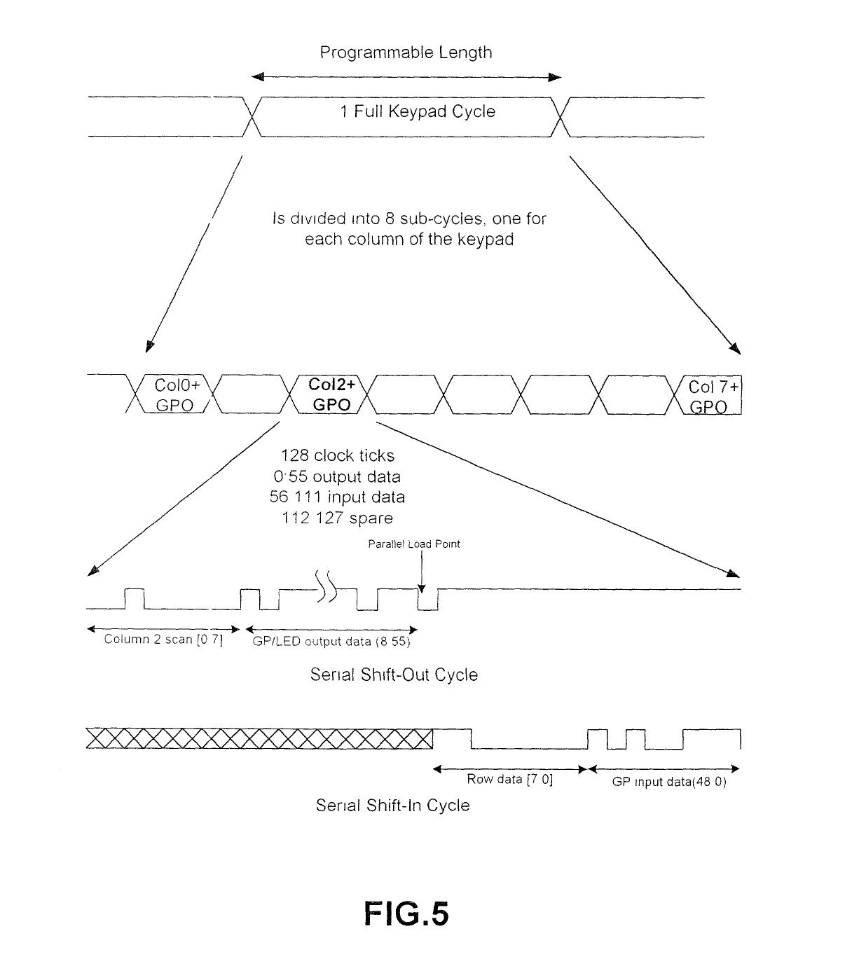

In a first ‘write’ cycle a keypad column scan block. to be described with reference to FIG. 5. will generate a column sequence 3-b001 This is a 3-bit word ‘001’ which will be loaded serially into the shift register controlling the column lines When the 3-bit work had been loaded serially into the shift register. so that in this example column 0 is ‘high’ or ‘1’. the PISO register is loaded in parallel If for example the key 3 is pressed while column 0 is selected. the value loaded into the PISO register is 3-b100. which indicates that row 0 is high and rows 1 and 2 are low For the sake of another example. if key 6 is depressed. the value returned in this sub-cycle is 3-b010 and so on

It is necessary under this scheme to provide a scanning cycle which comprises a multiplicity of sub-cycles. the number of sub-cycles corresponding to the number of columns In particular. in each sub-cycle a respective column is selected. one at a time in each sub-cycle. the sub-cycle For the scheme shown in FIG. 1. the scanning cycle comprises three sub-cycles for each of which there is a serial readout from the rows The combination of the column scan value and the row readout value will identify the key (or keys) that may be depressed

The various combinations of column scan values and row readout values of a 3 by 3 keypad as shown in FIG. 1 are as shown in FIG. 2 wherein the first column indicates the values in each sub-cycle in the shift register controlling the column lines. the second column indicates the possible row values and the third column indicates the corresponding key number identified by the combination of the column values and the row values

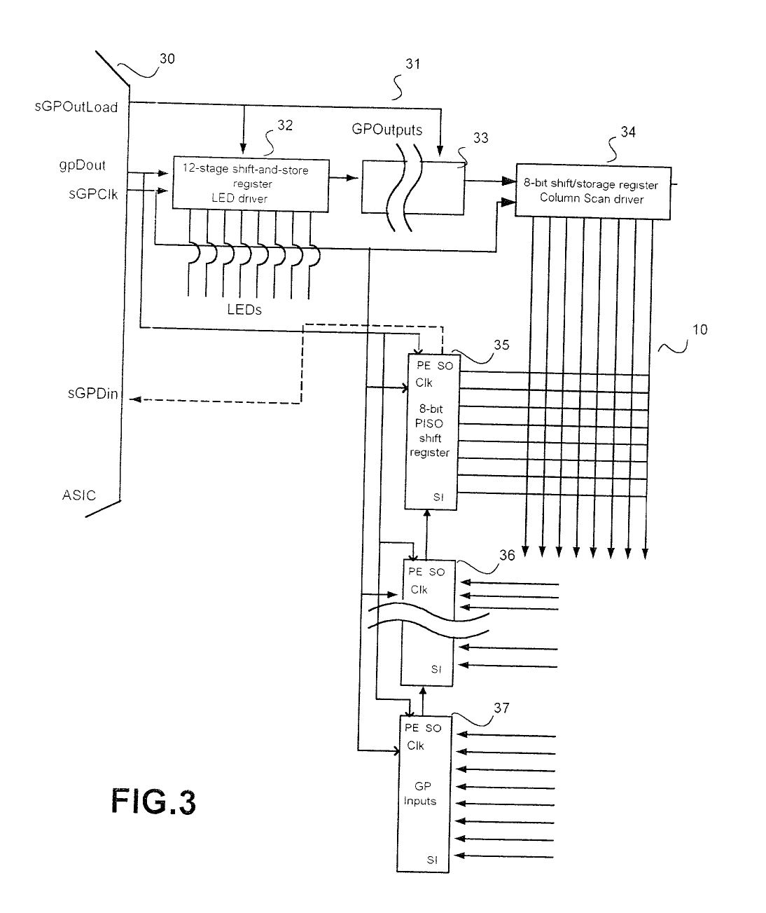

FIG. 3 illustrates an embodiment of the invention in conjunction with an ASIC 30 In this embodiment the scanning and readout is applied not only (in accordance with the invention) to registers associated with the keypad 10 but also (optionally) to other devices by means of the general purpose registers to be described The ASIC provides on a line 31 a load signal sGPOutLoad (at a time to be described) to various registers A serial signal sGPDout is clocked (by means of ‘sGPClk’ clocked out of ASIC on positive edge and clocked into shift registers on negative edge) through to a limited number of twelve stage shift and storage registers 32-33 (which act as LED drivers 32 and as shown as ‘GPOutputs’. an output path to GP outputs) and a shift register 34 constituting a column scan driver At a count of clock cycles equal to the number of outputs. (i e when the serial signal has been exactly shifted in to registers 32 to 34) the signal sGPOutLoad is asserted (c f FIG. 5) which drives the data (within registers 32-33) from each shift register to the associated storage registers Then on the next positive edge of the sGPClk. at which time all shift registers (but most importantly the column scan driver register) still contain the correct data. a LOW signal is sent to the active LOW Parallel Enable input of the 8-bit PISO shift register 35 which is coupled to the row lines of the keypad 10 This loads the register with bits each corresponding to the status of the respective row line The sGPOutLoad signal could be used (inverted) to drive the PE input but this requires the addition of an extra inverter

Although it is not directly relevant to the present invention. there may be further PISO registers of which two are shown at 36 and 37 also controlled by the clock signal and chained together with serial-outputs coupled to serial inputs The shift registers 36 and 37 and the rest may be arranged for reading in data from other devices which are scanned by the register in block 33. so that the signal sGPDin includes the bits [0 7] relevant to the row lines and subsequent bits read into the registers 36. 37 etc

FIG. 4 illustrates schematically the relevant operational blocks of the ASIC 30 A clock divider 40 generates the external shift register clock sGPClk which is provided to the registers 32-34 as described with reference to FIG. 3. It also provides a clock signal to a data controller 41 constituted by a 7-bit counter that controls the sequence of events that occur in the system In particular. at count 0. a new column scan value is initiated At a count equal to the number of outputs LED data may be applied to the LEDs by way of the scan storage register 32 the GP output data is latched into the general purpose output devices. the selected column of the keypad scanned and the resulting row values are loaded into the PISO register 35 The parallel loading (PE) of the PISO registers are enabled at the same time It may be desirable to latch the registers 32-34 on the leading edge of the load signal and to enable registers 35 to 37 on the trailing edge The load signal will last one clock ‘tick’ At a count equal o the number of outputs plus the number of inputs. the counter asserts a ‘DataInValid’ signal and latches the row data into a ‘key value’ register

The data controller therefore controls a serial shift-out block 42 which receives the current data keypad column scan output. GP data and LED data and serialises to send it out to the external shift registers 32 to 34 The keypad column scan is generated by block 43 and on each recycling of the data controller (count=0) changes the column scan value

The clock divider also controls a serial shift-in block 44 which shifts all external data. that is to say the GP inputs and the keypad row data. into the internal registers of the ASIC

The other blocks in FIG. 4 are a ‘Latch GPin data’ plus ‘Interrupt Detection’ block 45. a ‘KeyHit Determination’ block 46 and a keypad register bus interface 47

The ‘KeyHit Determination’ block determines whether a combination of the column scan value and the row value validly indicates a key (cf FIG. 2) and may provide to a CPU an interrupt to allow the operation governed by that key

During the first write cycle. the keypad column scan block generates the relevant column sequence which is sent out in serial format by the serial shift-out block by the external registers As indicated in the foregoing. the first write cycle is one which requires at column 0 and only column 0 is active This value is also sent to the KeyHit Determination block 46 and stored there until the resulting sensed row data is fed in from the external register 35

The scan data is shifted through the external registers and at the time when the scan sequence is present on the keypad columns. the PISO register 35 is loaded with the data which is sensed on the rows of the keypad

The row data. namely the output of the PISO register. along with the general purpose inputs. is serially fed into the serial shift-in block 44. converted to parallel form and latched into the block 45 with the GP inputs When valid data is present in this block. the row data. designated herein the ‘sensed row data’ is extracted and sent to the ‘KeyHit Determination’ block and latched into a key value holding register

FIG. 5 illustrated the division of a full keypad cycle into the sub-cycles

Each full keypad cycle is divided into eight sub-cycles. one for each column of the keypad As shown by the sub-cycle denoted Col2+GPO. each sub-cycle consists. in the present embodiment. of 128 bits each corresponding to a clock cycle Bits 0 55 represent output data sent to registers 32 to 34 and bits 56 111 represent input data whereas bits 112 127 are spare The third row of FIG. 5 shows the column 2 scan (8 bits) followed by, in abbreviated form. the general purpose and LED output data. (the next 48 bits) followed by the load point for the registers

The final line in FIG. 5 shows the serial shift-in cycle consisting of the row data. bus 0 7. followed by the general purpose input data. bits 8 55

1. A keypad scanner for a keypad comprising a multiplicity of rows and columns and an array of keys each operative to couple a respective column line and a respective row line. said scanner comprising
(a) a shift register having a multiplicity of stages each associated with a respective column line.
(b) a parallel-in. serial-out (PISO) register having a multiplicity of stages each coupled to a respective row line.
(c) means for applying to said shift register a scanning cycle comprising a multiplicity of sub-cycles. each comprising serial data signals identifying in each sub-cycle a single one of the column lines.
(d) means for loading said PISO register after said serial data signals in each sub-cycle with row data corresponding to signal values on the row lines. and
(e) means for shifting out serially the row data held in said PISO register

2. A keypad scanner according to claim 1 wherein each sub-cycle comprises said serial data signals and serial data bits corresponding to said row data in said PISO register

3. A keypad scanner according to claim 1 wherein said shift register includes a storage register for storing signals in the shift register in response to a load signal and wherein said means for loading provides after said serial data signals in each sub-cycle the said load signal and a signal to a parallel load enabling input of the PISO register

4. A keypad scanning system comprising
(i) a keypad comprising a multiplicity of rows and columns and an array of keys each operative to couple a respective column line and a respective row line.
(ii) a keypad scanner comprising
(a) a shift register having a multiplicity of stages each associated with a respective column line.
(b) a parallel-in. serial-out (PISO) register having a multiplicity of stages each coupled to a respective row line.
(c) means for applying to said shift register a scanning cycle comprising a multiplicity of sub-cycles. each comprising serial data signals identifying in each sub-cycle a single one of the column lines.
(d) means for loading said PISO register after said serial data signals in each sub-cycle with row data corresponding to signal values on the row lines. and
(e) means for shifting out serially the row data held in said PISO register. and
(iii) an application-specific integrated circuit including
means for generating a clock signal for said registers.
a serial shift-out block responsive to said clock signal to generate said scanning cycle in serial form.
a serial shift-in block responsive to said clock signal for receiving said row data in said PISO register in serial form.
a data controller responsive to said clock signal to control said serial shift-out block. said data controller initiating a new column scan value on completion of a recycling count. and
means responsive to said data controller and said serial shift-in block to latch said row data.

5. A keypad scanning system according to claim 4 wherein each sub-cycle comprises said serial data signals and serial data bits corresponding to said row data in said PISO register

6. A keypad scanning system according to claim 4 wherein said shift register includes a storage register for storing signals in the shift register in response to a load signal and wherein said means for loading provides after said serial data signals in each sub-cycle the said load signal and a signal to a parallel load enabling input of the PISO register
